(19) United States
(12) Patent Application Publication
(10) Pub. No.: US 2026/0228958 A1
(43) Pub. Date: Aug. 6, 2026

(54) DATA OBTAINING METHOD AND APPARATUS, TERMINAL, AND READABLE STORAGE MEDIUM

(71) Applicant: VIVO MOBILE COMMUNICATION CO., LTD., Guangdong (CN)

(72) Inventors: Huan WANG, Guangdong (CN); Zhuoyi Lv, Guangdong (CN)

(73) Assignee: VIVO MOBILE COMMUNICATION CO., LTD., Guangdong (CN)

(21) Appl. No.: 19/645,805

(22) Filed: Apr. 13, 2026

Related U.S. Application Data
(63) Continuation of application No. PCT/CN2024/123302, filed on Oct. 8, 2024.

(30) Foreign Application Priority Data
Oct. 13, 2023 (CN) 202311333968.1

(51) Int. Cl. G06T 15/00; G06F 3/01

(52) U.S. Cl. CPC G06T 15/005; G06F 3/016

(57) ABSTRACT

This application relates to a data obtaining method and apparatus, a terminal, and a readable storage medium. The method includes: monitoring, by a rendering engine, a target node or a target object; and obtaining, by the rendering engine, target data based on a target property associated with the target node or the target object; where the target property includes a time property.

### CROSS-REFERENCE TO RELATED APPLICATIONS

This application is a continuation application of PCT International Application No. PCT/CN2024/123302 filed on Oct. 8, 2024, which claims priority to Chinese Patent Application No. 202311333968.1, filed on Oct. 13, 2023, which is incorporated herein by reference in its entirety.

### TECHNICAL FIELD

This application relates to the field of communication technologies, and in particular, to a data obtaining method and apparatus, a terminal, and a readable storage medium.

### BACKGROUND

In the related art, a haptic signal processing model in a scene description (SD) standard is implemented based on a trigger triggering a haptic action. A current processing model is not flexible enough in a triggering manner for haptic data processing, and cannot process a condition of a non-interactive scenario.

### SUMMARY

Embodiments of this application provide a data obtaining method and apparatus, a terminal, and a readable storage medium.

According to a first aspect, a data obtaining method is provided, including:
monitoring, by a rendering engine, a target node or a target object; and
obtaining, by the rendering engine, target data based on a target property associated with the target node or the target object;
where the target property includes a time property.

According to a second aspect, a data obtaining apparatus is provided, including:
a monitoring module, configured to monitor a target node or a target object through a rendering engine; and
an obtaining module, configured to obtain target data based on a target property associated with the target node or the target object through the rendering engine;
where the target property includes a time property.

According to a third aspect, a terminal is provided. The terminal includes a processor and a memory. The memory stores a program or instructions executable in the processor. The program or the instructions, when executed by the processor, implement the steps of the method according to the first aspect.

According to a fourth aspect, a terminal is provided, including a processor and a communication interface. The processor is configured to monitor a target node or a target object through a rendering engine; and
obtain target data based on a target property associated with the target node or the target object through the rendering engine;
where the target property includes a time property.

According to a fifth aspect, a network-side device is provided. The network-side device includes a processor and a memory. The memory stores a program or instructions executable in the processor. The program or the instructions, when executed by the processor, implement the steps of the method according to the first aspect.

According to a sixth aspect, a network-side device is provided, including a processor and a communication interface. The processor is configured to monitor a target node or a target object through a rendering engine; and
obtain target data based on a target property associated with the target node or the target object through the rendering engine;
where the target property includes a time property.

According to a seventh aspect, a readable storage medium is provided. The readable storage medium stores a program or instructions. The program or the instructions, when executed by a processor, implement the steps of the method according to the first aspect.

According to an eighth aspect, a chip is provided. The chip includes a processor and a communication interface. The communication interface is coupled to the processor. The processor is configured to run a program or instructions to implement the method according to the first aspect.

According to a ninth aspect, a computer program/program product is provided. The computer program/program product is stored in a storage medium, and the program/program product is executed by at least one processor to implement the method according to the first aspect.

### BRIEF DESCRIPTION OF THE DRAWINGS

FIG. 1 is a block diagram of a wireless communication system to which embodiments of this application may be applied;

FIG. 2 is a schematic flowchart of a data obtaining method according to an embodiment of this application;

FIG. 3 is a schematic structural diagram of a data obtaining apparatus according to an embodiment of this application;

FIG. 4 is a schematic structural diagram of a communication device according to an embodiment of this application;

FIG. 5 is a schematic structural diagram of a terminal according to an embodiment of this application;

FIG. 6 is a schematic structural diagram 1 of a network-side device according to an embodiment of this application; and

FIG. 7 is a schematic structural diagram 2 of the network-side device according to an embodiment of this application.

### DETAILED DESCRIPTION

Technical solutions in embodiments of this application are clearly described below with reference to drawings in embodiments of this application. Apparently, the described embodiments are merely some rather than all embodiments of this application.

Terms “first”, “second”, and the like in this application are used for distinguishing between similar objects rather than describing a specific order or sequence. It should be understood that the terms used in this way may be transposed where appropriate, so that embodiments of this application can be implemented in a sequence other than those illustrated or described herein. In addition, objects defined by “first” and “second” are generally of the same class and do not limit a quantity of objects. For example, one or more first objects may be arranged. In addition, “or” in this application indicates at least one of connected objects. For example, “A or B” encompasses three solutions: solution 1: A is included but B is not included; solution 2: B is included but A is not included; and solution 3: both A and B are included. The character “/” generally indicates an “or” relationship between a preceding associated object and a succeeding associated object.

A term “indication” in this application may be a direct indication (or an explicit indication) or an indirect indication (or an implicit indication). The direct instruction may be understood as that a sending party clearly informs a receiving party of specific information, an operation to be performed, or a request result in the sent instruction. The indirect indication may be understood as that the receiving party determines corresponding information based on an indication sent by the sending party, or makes a determination and determines, based on a determining result, an operation that needs to be performed or a request result.

It should be noted that the technology described in embodiments of this application may be applied to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. Terms “system” and “network” in embodiments of this application are usually used interchangeably, and the described technology may be used for both the system and the radio technology mentioned above, or may be used for another system and another radio technology. A new radio (NR) system is described below as an example, and the term NR is used in most of the following description. However, the technologies may also be applied to systems other than the NR system, such as a 6th generation (6G) communication system.

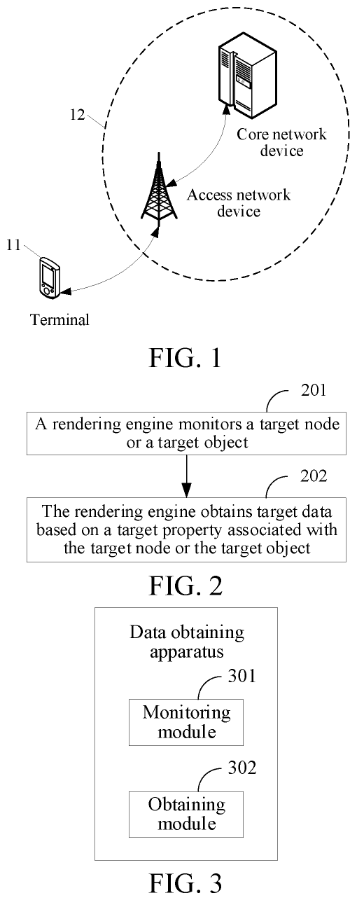

FIG. 1 is a block diagram of a wireless communication system to which embodiments of this application may be applied. The wireless communication system includes a terminal 11 and a network-side device 12. The terminal 11 may be a terminal side device such as a mobile phone, a tablet computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, an on-board device (VUE), a shipborne device, a pedestrian terminal (PUE), a smart home appliance (a home device with a wireless communication capability, such as a refrigerator, a television, a washing machine, or furniture), a game console, a personal computer (PC), a teller machine, or a self-service machine. The wearable device includes a smart watch, a smart bracelet, a smart headset, smart glasses, smart jewelry (a smart wristlet, a smart chain bracelet, a smart ring, a smart necklace, a smart ankle, a smart ankle chain, and the like), a smart wristband, smart clothing, and the like. The on-board device may also be referred to as an on-board terminal, an on-board controller, an on-board module, an on-board component, an on-board chip, an on-board unit, or the like. It should be noted that a specific type of the terminal 11 is not limited in embodiments of this application. The network-side device 12 may include an access network device or a core network device, where the access network device may also be referred to as a radio access network (RAN) device, a radio access network function, or a radio access network unit. The access network device may include a base station, a wireless local area network (WLAN) access point (AP), a wireless fidelity (WiFi) node, or the like. The base station may be referred to as a node B (NB), an evolved node B (eNB), a next generation node B (gNB), a new radio node B (NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B, a transmission receiving point (TRP), or another appropriate term in the art. The base station is not limited to a specific technical term, as long as the same technical effect can be achieved. It should be noted that, in embodiments of this application, only a base station in an NR system is used as an example for description, and a specific type of the base station is not limited.

The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in embodiments of this application, only a core network device in the NR system is used as an example, and a specific type of the core network device is not limited.

To better understand the technical solutions of this application, the following content is first described.

### Topology of Haptic Immersive Content

Haptic media content may be classified into four types, namely, story-driven content, experience-driven content, event-driven content, and interaction-driven content.

For the story-driven content, an experiencer may be immersed in a story, such as a television or a movie. To enhance experience during the story, haptic feedback may be used for a singular moment/an important scene (for example, the experiencer feels vibration feedback in an earthquake scene and feels wind in a windy scene).

Graphic Language Transmission Format (glTF) Interactivity Extension

The glTF is used for an engine and an application program to efficiently transmit and load a 3D scene and a model. The glTF defines an extensible posting format. Interoperable use of 3D content in an entire industry is implemented, thereby simplifying an authoring workflow and an interactive service.

The Moving Picture Expert Group (MPEG) performs an interactivity extension on the glTF, preliminarily designing a related standard for interactivity. In a haptic scene, the related standard for interactivity is mainly used for describing an interaction between an avatar and a haptic source. Based on the above, a haptic signal is triggered and generated.

The interactivity is defined based on a behavior. The behavior includes a trigger condition node (i.e., trigger node) and an action node (i.e., action node). The trigger includes a collision condition, a proximity condition, and a visibility condition. The action includes a haptic feedback action (i.e., set haptic) and the like.

For a haptic feedback action condition, several parameters for haptic signal generation and playing are defined in an action. For details, reference may be made to Table 1 and Table 2 below. Table 1 shows semantics of an action, and Table 2 shows semantics of a HapticActionNode object.

TABLE 1

| Name | Type | Usage | Default | Description |
|---|---|---|---|---|
| if (type == | | | | |
| ACTION_SET_HAPTIC){ | | | | |
| Haptic action node | Array | M | N/A | List of haptic action |
| (hapticActionNodes) | (HapticActionNode) | | | nodes |
| } | | | | |

TABLE 2

| Property | Type | Required | Default | Description |
|---|---|---|---|---|
| Node | Integer | M | N/A | ID of a node in a |
| | | | | glTF node array |
| | | | | (Id of the node in |
| | | | | the glTF nodes |
| | | | | array) |
| Action location | Integer | O | 0xFFFFFFFF | Body part mask, |
| (actionLocation) | | | | used for |
| | | | | specifying a |
| | | | | position on a |
| | | | | body where a |
| | | | | signal is |
| | | | | rendered. |
| Washout | Boolean value | O | False | Specifies |
| | (boolean) | | | whether an |
| | | | | operation should |
| | | | | trigger a washout |
| | | | | (reset to an initial |
| | | | | state) of an |
| | | | | associated device |
| | | | | (Specifies |
| | | | | whether the |
| | | | | action should |
| | | | | trigger a washout |
| | | | | (reset to the |
| | | | | origin) of the |
| | | | | associated |
| | | | | devices). |
| Use of a collider | Boolean | O | False | Used with a |
| (useCollider) | | | | collision trigger |
| | | | | condition. If true, |
| | | | | a rendering |
| | | | | engine shall use |
| | | | | collision |
| | | | | information to |
| | | | | estimate a |
| | | | | position on a |
| | | | | body where |
| | | | | haptic feedback |
| | | | | is applied. If |
| | | | | false, a signal |
| | | | | shall be rendered |
| | | | | based on |
| | | | | information |
| | | | | specified in a |
| | | | | haptic file (Used |
| | | | | with a Collision |
| | | | | trigger. If True, |
| | | | | the rendering |
| | | | | engine shall use |
| | | | | collision |
| | | | | information to |
| | | | | estimate the |
| | | | | desired location |
| | | | | of the haptic |
| | | | | feedback on the |
| | | | | body. If false, the |
| | | | | signal shall be |
| | | | | rendered based |
| | | | | on the |
| | | | | information |
| | | | | specified in the |
| | | | | Haptic file). |
| Material haptic modality | Array (enumeration) | O | N/A | For a list of |
| (materialHapticModality) | (array (enum)) | | | haptic material |
| | | | | modalities that |
| | | | | shall be rendered, |
| | | | | possible values |
| | | | | are described in |
| | | | | detail in Table |
| | | | | 8.2-11 (List of |
| | | | | haptic material |
| | | | | modalities that |
| | | | | shall be rendered. |
| | | | | Possible values |
| | | | | are detailed in |
| | | | | Table 8.2-11). |
| Haptic action medium | Array | M | N/A | List of the haptic |
| (hapticActionMedias) | (HapticActionMedia) | | | action media |
| | | | | (List of Haptic |
| | | | | Action Media) |

### Processing Model of Haptic Feedback

For a to-be-processed scene description file, the rendering engine performs the following steps:
(1) parsing a related glTF file;
(2) detecting whether MPEG_haptic and MPEG_haptic_material extension are included in the scene description file; and
(3) identifying a node related to haptic feedback through analysis of a haptic action node defined in an interactivity extension.

During run time, the rendering engine performs the following steps:
(1) The rendering engine obtains haptic data in a related haptic object through a media access function (MAF) application programming interface (API) if a trigger node in a haptic behavior triggers a haptic action; and
(2) the rendering engine renders the haptic data based on a feature in the haptic action node.

The data obtaining method provided in embodiments of this application is described below in detail through some embodiments and application scenarios with reference to the drawings.

Referring to FIG. 2, embodiments of this application provide a data obtaining method. An execution body of the method is a rendering engine. It should be noted that the rendering engine may be deployed in a cloud (such as a server) or a terminal. A specific location where the rendering engine is deployed is not limited in embodiments of this application. The method may be specifically performed by the rendering engine in a form of a haptic feedback processing model.

The method includes:
Step 201: A rendering engine monitors a target node or a target object.
Step 202: The rendering engine obtains target data based on a target property associated with the target node or the target object.

The rendering engine is configured to synthesize and play an audio, a video, and tactility in a scene based on obtained SD information.

In some optional implementations, the target property includes a time property.

In embodiments of this application, the target node or the target object that has the time property is introduced, the rendering engine obtains the target data based on the time property associated with the target node or the target object, and time trigger-based data processing is implemented, so that the data processing is more flexible.

It should be noted that the target data may include haptic data, audio data, video data, and the like. Types of the target data are not specifically limited in embodiments of this application. It may be understood that, for ease of understanding the solution, an example in which the target data is the haptic data is used in descriptions of the following embodiments to describe the solution.

In a possible implementation, the target node or the target object includes at least one of the following:
(1) a haptic source node or a haptic source object, where the haptic source is a node or object that generates a haptic signal;
(2) a trigger node or a trigger object;
(3) a behavior node or a behavior object; or
(4) a haptic action node or a haptic action object.

Specific implementations corresponding to different types of target nodes or target objects are described below:

### Implementation 1:

Obtaining, by a rendering engine, target data based on a target property associated with a target node or a target object when the target node or the target object is a haptic source node or a haptic source object includes:
obtaining, by the rendering engine, the target data based on a first target property associated with the haptic source node or the haptic source object.

The first target property includes a time property.

In embodiments of this application, the haptic source node or the haptic source object (briefly referred to as a haptic source node/object) is introduced, and a haptic feedback processing model allows the rendering engine to monitor the haptic source node/object and directly obtain and render the haptic data based on a property corresponding to the haptic source node/object. Since the property of the haptic source node/object includes the time property, the time trigger-based data processing can be implemented in this manner.

### Implementation 2:

Obtaining, by a rendering engine, target data based on a target property associated with a target node or a target object when the target node or the target object is a trigger node or a trigger object includes:
obtaining, by the rendering engine, the target data based on a second target property associated with the trigger node or the trigger object.

The second target property includes a time property.

In embodiments of this application, a haptic action is triggered based on a trigger, and then the haptic data is obtained and rendered based on a property corresponding to the node/object. To support time trigger-based data processing, a trigger type needs to be added in a protocol. To be specific, a time property of the trigger node/object is added to describe a time/scene switching-based trigger condition. Since the property of the trigger node/object includes the time property, the time trigger-based data processing can be implemented in this manner.

### Implementation 3:

Obtaining, by a rendering engine, target data based on a target property associated with a target node or a target object when the target node or the target object is a behavior node or a behavior object includes:
obtaining, by the rendering engine, the target data based on a third target property associated with the behavior node or the behavior object.

The third target property includes a time property.

In embodiments of this application, to support time trigger-based data processing, a behavior type needs to be added in a protocol. To be specific, a time property of the behavior node/object is added to describe a time/scene switching-based trigger condition. Since the property of the behavior node/object includes the time property, the time trigger-based data processing can be implemented in this manner.

### Implementation 4:

Obtaining, by a rendering engine, target data based on a target property associated with a target node or a target object when the target node or the target object is a haptic action node or a haptic action object includes:
obtaining, by the rendering engine, the target data based on a fourth target property associated with the haptic action node or the haptic action object.

The fourth target property includes a time property.

In embodiments of this application, a haptic action is triggered based on a trigger, and then the haptic data is obtained and rendered based on a property corresponding to the node/object. To support time trigger-based data processing, a haptic action type needs to be added in a protocol. To be specific, a time property of the haptic action node/object is added to describe a time/scene switching-based trigger condition. Since the property of the haptic action node/object includes the time property, the time trigger-based data processing can be implemented in this manner.

In a possible implementation, a target property is in a default state. Obtaining, by a rendering engine, target data based on a target property associated with a target node or a target object includes:
obtaining, by the rendering engine, the target data at any time.

In embodiments of this application, the default state is used for indicating that the rendering engine may obtain the target data at any time.

In a possible implementation, monitoring, by a rendering engine, a target node or a target object includes:
monitoring, by the rendering engine, a haptic action node or a haptic action object when a trigger node or a trigger object is in a preset state.

In embodiments of this application, the trigger node/object in a behavior node/object is allowed to be in a default state. When the trigger node or the trigger object is in the preset state, the trigger node or the trigger object is in a triggered state. To be specific, it is determined by default that the haptic action node/object can definitely trigger the trigger node/object (for example, existing triggering based on a condition such as collision or playing based on time), which indicates that the haptic action node/object in the behavior node/object is always in an activated state. The rendering engine may always obtain and render haptic data based on a property corresponding to the activated haptic action node/object.

In a possible implementation, the time property includes at least one of the following:

(1) First Property, Used for Indicating a Time when the Rendering Engine Starts Rendering the Target Data

The first property may be referred to as a start time and is used for indicating when a rendering engine starts rendering media information associated with a node/object.

(2) Second Property, Used for Indicating Whether to Play Immediately when the Target Data is Ready

The second property may be referred to as auto play for indicating whether to play a media signal immediately when it is ready, and the indication may be performed in a form of a flag.

Optionally, a description file needs to carry at least one of the startTime and the autoplay.

(3) Third Property, Used for Indicating a Time when the Playback of the Target Data Starts

The third property may be referred to as a start time offset for indicating a time point in a time media at which playing starts. The startTimeOffset indicates a time offset of a source, and a timed media starts to be generated from the position, where 0 corresponds to starting of the source.

(4) Fourth Property, Used for Indicating a Time when the Playback of the Target Data Ends

The fourth property may be referred to as an end time offset for indicating a time point in a time media at which playing ends. The endTimeOffset indicates a time offset of a source, and a timed media starts to be generated from that time. The value is provided in seconds, where 0 corresponds to a start time of a source.

(5) Fifth Property, Used for Indicating Whether the Target Data is Repeatedly Played after the Playback Ends

The fifth property may be referred to as a loop. The startTime is used for indicating whether a media signal is repeatedly played after playing ends. The indication may be performed in a form of a flag.

### (6) Sixth Property, Used for Indicating a Playback Period of Target Data

The sixth property may be referred to as a signal playback period.

In a possible implementation, a target property includes a time property and a seventh property, and the seventh property is used for indicating a trigger type of the target data.

The seventh property may be referred to as a playback mode and is used for indicating a trigger type of a signal feedback associated with a node/object. For example, the trigger type includes at least one of the following: triggering based on an event (the event may be, for example, explosion), triggering based on an interactivity-defined trigger condition, triggering based on a non-event, triggering based on time, triggering based on a scene (the event may be, for example, rain and snow), permanent triggering, or the like.

For example, the Playback mode may be selected from continuous and event. A continuous mode is continuously triggering, and an event mode is triggering based on an event.

An execution body of the data obtaining method provided in embodiments of this application may be a data obtaining apparatus. In embodiments of this application, a data obtaining apparatus provided in embodiments of this application is described by using an example in which the data obtaining apparatus performs the data obtaining method.

Referring to FIG. 3, embodiments of this application provide a data obtaining apparatus, including:
a monitoring module 301, configured to monitor a target node or a target object through a rendering engine; and
an obtaining module 302, configured to obtain target data based on a target property associated with the target node or the target object through the rendering engine.

The target property includes a time property.

Optionally, the target node or the target object includes at least one of the following:
a haptic source node or a haptic source object;
a trigger node or a trigger object;
a behavior node or a behavior object; or
a haptic action node or a haptic action object.

Optionally, when the target node or the target object is the haptic source node or the haptic source object, the obtaining module is configured to:
obtain the target data based on a first target property associated with the haptic source node or the haptic source object through the rendering engine.

The first target property includes the time property.

Optionally, when the target node or the target object is the trigger node or the trigger object, the obtaining module is configured to:
obtain the target data based on a second target property associated with the trigger node or the trigger object through the rendering engine.

The second target property includes the time property.

Optionally, when the target node or the target object is the behavior node or behavior object, the obtaining module is configured to:
obtain the target data based on a third target property associated with the behavior node or the behavior object through the rendering engine.

The third target property includes the time property.

Optionally, when the target node or the target object is the haptic action node or the haptic action object, the obtaining module is configured to:
obtain the target data based on a fourth target property associated with the haptic action node or the haptic action object through the rendering engine.

The fourth target property includes the time property.

Optionally, the target property is in a default state, and the obtaining module is configured to:
obtain the target data at any time through the rendering engine.

Optionally, the obtaining module is configured to:
monitor the haptic action node or the haptic action object through the rendering engine when the trigger node or the trigger object is in a preset state.

Optionally, the time property includes at least one of the following:
a first property, used for indicating a time when the rendering engine starts rendering the target data;
a second property, used for indicating whether to play immediately when the target data is ready;
a third property, used for indicating a time when playback of the target data starts;
a fourth property, used for indicating a time when the playback of the target data ends;
a fifth property, used for indicating whether the target data is repeatedly played after the playback ends; or
a sixth property, used for indicating a playback period of the target data.

Optionally, the target property includes at least one of the time property and a seventh property, and the seventh property is used for indicating a trigger type of the target data.

The data obtaining apparatus in embodiments of this application may be an electronic device, for example, an electronic device with an operating system, or may be a component in an electronic device, for example, an integrated circuit or a chip. The electronic device may be a terminal, or may be another device other than a terminal. For example, the terminal may include, but is not limited to, the foregoing listed types of the terminal 11. The another device may be a server, a network attached storage (NAS), or the like, which is not specifically limited in embodiments of this application.

The data obtaining apparatus provided in embodiments of this application can implement the processes implemented in the method embodiment of FIG. 2, and achieve the same technical effect. To avoid repetition, details are not described herein again.

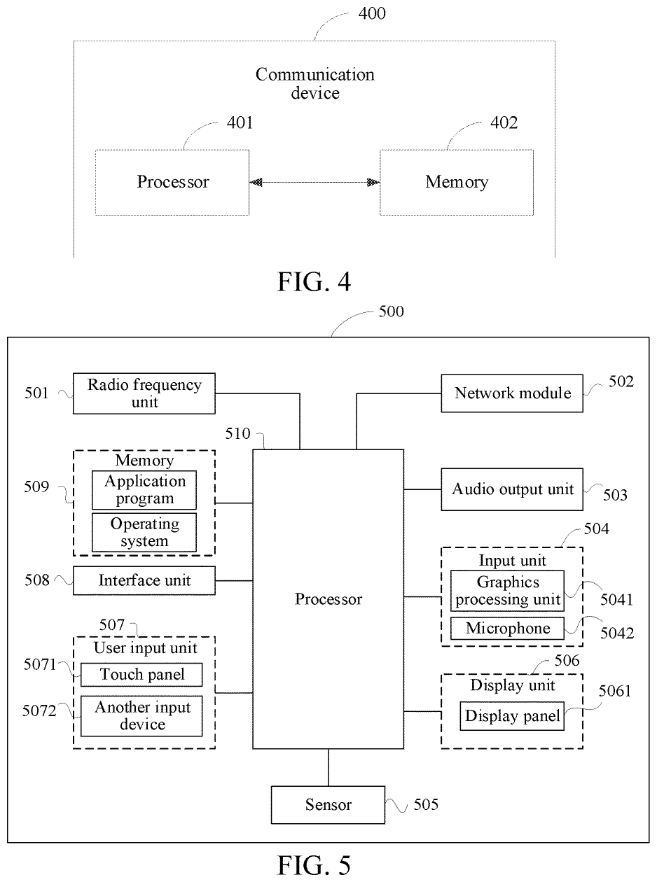

As shown in FIG. 4, an embodiment of this application further provides a communication device 400, including a processor 401 and a memory 402. The memory 402 stores a program or instructions executable in the processor 401. For example, when the communication device 400 is a terminal, the program or the instructions, when executed by the processor 401, implement the steps of the foregoing method embodiments, and can achieve the same technical effect. When the communication device 400 is a network-side device, the program or the instructions, when executed by the processor 401, implement the steps in the foregoing method embodiments, and can achieve the same technical effect. To avoid repetition, details are not described herein again.

An embodiment of this application further provides a terminal, including a processor and a communication interface. The communication interface is coupled to the processor, and the processor is configured to run a program or instructions, to implement the steps of the method embodiments. The terminal embodiment corresponds to the foregoing method embodiment of the terminal side. The implementation processes and implementations of the foregoing method embodiment are all applicable to the terminal embodiment, and can achieve the same technical effect. Specifically, FIG. 5 is a schematic diagram of a hardware structure of a terminal for implementing an embodiment of this application.

The terminal 500 includes, but is not limited to, at least some components such as a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (such as a battery) for supplying power to the components. The power supply may be logically connected to the processor 510 through a power management system, thereby implementing functions such as charging, discharging, and power consumption management through the power management system. The terminal structure shown in FIG. 5 constitutes no limitation on the terminal, and the terminal may include more or fewer components than those shown in the figure, or some merged components, or different component arrangements. Details are not described herein again.

It should be understood that in embodiments of this application, the input unit 504 may include a graphics processing unit (GPU) 5041 and a microphone 5042. The graphics processing unit 5041 processes image data of a static picture or a video obtained by an image capturing apparatus (for example, a camera) in a video capturing mode or an image capturing mode. The display unit 506 may include a display panel 5061. The display panel 5061 may be configured in a form such as a liquid crystal display or an organic light-emitting diode. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include, but is not limited to, a physical keyboard, a function key (such as a volume control key or a switch key), a track ball, a mouse, and a joystick. Details are not described herein again.

In embodiments of this application, the radio frequency unit 501 receives downlink data from a network-side device and may transmit the downlink data to the processor 510 for processing. In addition, the radio frequency unit 501 may send uplink data to the network-side device. Generally, the radio frequency unit 501 includes, but is not limited to, an antenna, an amplifier, a transceiver, a coupler, a low noise amplifier, a duplexer, and the like.

The memory 509 may be configured to store a software program or instructions and various data. The memory 509 may mainly include a first storage area storing a program or instructions and a second storage area storing data. The first storage area may store an operating system, an application program, or instructions required by at least one function (such as a sound playing function and an image displaying function), and the like. In addition, the memory 509 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 509 in embodiments of this application includes, but is not limited to, these and any other suitable types of memories.

The processor 510 may include one or more processing units. Optionally, the processor 510 integrates an application processor and a modem processor. The application processor mainly processes operations related to an operating system, a user interface, an application program, and the like. The modem processor mainly processes wireless communication signals, and is, for example, a baseband processor. It may be understood that the modem processor may alternatively not be integrated into the processor 510.

The processor 510 is configured to monitor a target node or a target object through a rendering engine.

The processor 510 is configured to obtain target data based on a target property associated with the target node or the target object through the rendering engine.

The target property includes a time property.

Optionally, the target node or the target object includes at least one of the following:
a haptic source node or a haptic source object;
a trigger node or a trigger object;
a behavior node or a behavior object; or
a haptic action node or a haptic action object.

Optionally, when the target node or the target object is the haptic source node or haptic source object, the processor 510 is configured to:
obtain the target data based on a first target property associated with the haptic source node or the haptic source object through the rendering engine.

The first target property includes the time property.

Optionally, when the target node or the target object is the trigger node or the trigger object, the processor 510 is configured to:
obtain the target data based on a second target property associated with the trigger node or the trigger object through the rendering engine.

The second target property includes the time property.

Optionally, when the target node or the target object is the behavior node or behavior object, the processor 510 is configured to:
obtain the target data based on a third target property associated with the behavior node or the behavior object through the rendering engine.

The third target property includes the time property.

Optionally, when the target node or the target object is the haptic action node or haptic action object, the processor 510 is configured to:
obtain the target data based on a fourth target property associated with the haptic action node or the haptic action object through the rendering engine.

The fourth target property includes the time property.

Optionally, the target property is in a default state, and the processor 510 is configured to:
obtain the target data at any time through the rendering engine.

Optionally, the processor 510 is configured to:
monitor the haptic action node or the haptic action object through the rendering engine when the trigger node or the trigger object is in a preset state.

Optionally, the time property includes at least one of the following:
a first property, used for indicating a time when the rendering engine starts rendering the target data;
a second property, used for indicating whether to play immediately when the target data is ready;
a third property, used for indicating a time when playback of the target data starts;
a fourth property, used for indicating a time when the playback of the target data ends;
a fifth property, used for indicating whether the target data is repeatedly played after the playback ends; or
a sixth property, used for indicating a playback period of the target data.

Optionally, the target property includes at least one of the time property and a seventh property, and the seventh property is used for indicating a trigger type of the target data.

It may be understood that for the implementation process of each implementation mentioned in this embodiment, reference may be made to the relevant description in the method embodiments, and the same or corresponding technical effects can be achieved. To avoid repetition, details are not described herein again.

Embodiments of this application further provide a network-side device, including a processor and a communication interface. The communication interface is coupled to the processor, and the processor is configured to run a program or instructions, to implement the steps of the method embodiments. An embodiment of the network-side device corresponds to the foregoing method embodiment of the network-side device. Each implementation process and implementation of the foregoing method embodiment can be applied to the embodiment of the network-side device, and can achieve the same technical effects.

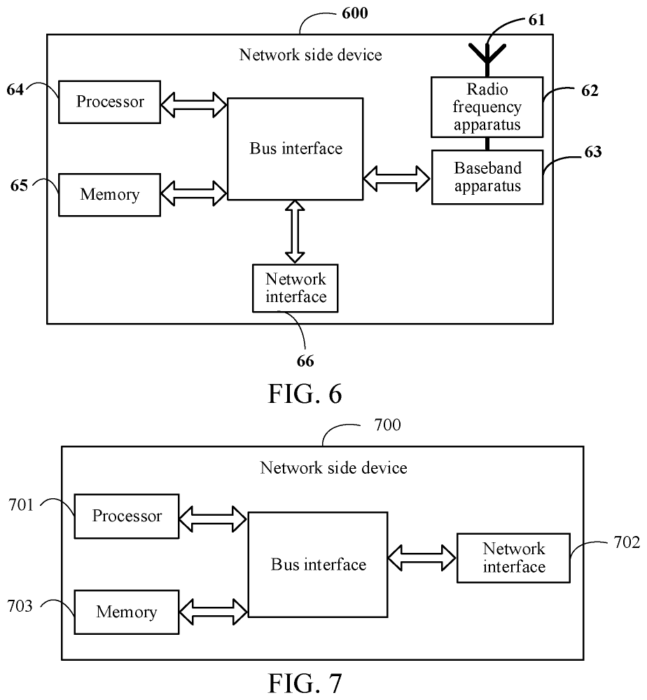

Specifically, an embodiment of this application further provides a network-side device. As shown in FIG. 6, the network-side device 600 includes: an antenna 61, a radio frequency apparatus 62, a baseband apparatus 63, a processor 64, and a memory 65. The antenna 61 is connected to the radio frequency apparatus 62. In an uplink direction, the radio frequency apparatus 62 receives information through the antenna 61 and sends the received information to the baseband apparatus 63 for processing. In a downlink direction, the baseband apparatus 63 processes to-be-sent information and sends the processed to-be-sent information to the radio frequency apparatus 62. The radio frequency apparatus 62 processes the received information and then sends the processed received information through the antenna 61.

The method performed by the network-side device in the foregoing embodiment may be implemented in the baseband apparatus 63. The baseband apparatus 63 includes a baseband processor.

The baseband apparatus 63 may include, for example, at least one baseband board. The baseband board is provided with a plurality of chips. As shown in FIG. 6, one of the chips may be, for example, a baseband processor and is connected to the memory 65 through a bus interface, to invoke a program in the memory 65 to perform the operations of the network device shown in the foregoing method embodiments.

The network-side device may further include a network interface 66, and the interface, for example, is a common public radio interface (CPRI).

Specifically, the network-side device 600 in embodiments of the present invention further includes: instructions or a program stored in the memory 65 and executable in the processor 64. The processor 64 invokes the instructions or the program in the memory 65 to perform the method executed by each module shown in FIG. 4 and achieves the same technical effect. To avoid repetition, details are not repeated herein.

Specifically, an embodiment of this application further provides a network-side device. As shown in FIG. 7, the network-side device 700 includes: a processor 701, a network interface 702, and a memory 703. The network interface 702 is, for example, a common public radio interface (CPRI).

Specifically, the network-side device 700 in embodiments of the present invention further includes: instructions or a program stored in the memory 703 and executable in the processor 701. The processor 701 invokes the instructions or the program in the memory 703 to perform the method executed by each module shown in FIG. 4 and achieves the same technical effect. To avoid repetition, details are not repeated herein.

Embodiments of this application further provide a readable storage medium. The readable storage medium stores a program or instructions. The program or the instructions, when executed by a processor, implement the processes of the foregoing method embodiments, and can achieve the same technical effect. To avoid repetition, details are not described herein.

The processor is a processor in the terminal described in the foregoing embodiments. The readable storage medium includes a computer-readable storage medium, such as a computer read-only memory ROM, a random access memory RAM, a floppy disk, or an optical disc. In some examples, the readable storage medium may be a non-transitory readable storage medium.

Embodiments of this application further provide a chip. The chip includes a processor and a communication interface. The communication interface is coupled to the processor. The processor is configured to run a program or instructions to implement the processes of the foregoing method embodiments and can achieve the same technical effect. To avoid repetition, details are not described herein again.

It should be understood that the chip mentioned in embodiments of this application may also be referred to as a system level chip, a system chip, a chip system, a system on chip, or the like.

Embodiments of this application further provide a computer program/program product. The computer program/program product is stored in a storage medium. The computer program/program product is executed by at least one processor to implement the processes of the foregoing method embodiments and can achieve the same technical effect. To avoid repetition, details are not described herein again.

It should be noted that in this specification, terms “comprise”, “include” or any other variants herein are intended to encompass non-exclusive inclusion, so that a process, a method, an article, or an apparatus including a series of elements not only include those elements, but also includes another element not listed explicitly or includes intrinsic elements for the process, the method, the article, or the apparatus. Without any further limitation, an element defined by the phrase “include one . . . ” does not exclude existence of an additional same element in the process, the method, the article, or the device that includes the element. In addition, it should be noted that the scope of the method and the apparatus in the implementations of this application is not limited to function execution in the order shown or discussed, and may further include function execution in a substantially simultaneous manner or in a reverse order based on the involved functions. For example, the described method may be performed in an order different from the described order, and various steps may also be added, omitted, or combined. In addition, features described with reference to some examples may be combined in another example.

According to the descriptions of the foregoing implementations, a person skilled in the art may clearly understand that the method in the foregoing embodiments may be implemented by a computer software product with a necessary universal hardware platform, or may certainly be implemented by hardware. The computer software product is stored in a storage medium (for example, a ROM, a RAM, a magnetic disk, or an optical disc), and includes several instructions, to enable a terminal or a network-side device to perform the method in embodiments of this application.

Although embodiments of this application are described above with reference to the accompanying drawings, this application is not limited to the foregoing specific implementations. The foregoing specific implementations are illustrative only but not restrictive.

What is claimed is:

1. A data obtaining method, comprising:
monitoring, by a rendering engine, a target node or a target object; and
obtaining, by the rendering engine, target data based on a target property associated with the target node or the target object,
wherein the target property comprises a time property.

2. The method according to claim 1, wherein the time property comprises at least one of the following:
a first property, used for indicating a time when the rendering engine starts rendering the target data;
a second property, used for indicating whether to play immediately when the target data is ready;
a third property, used for indicating a time when playback of the target data starts;
a fourth property, used for indicating a time when the playback of the target data ends;
a fifth property, used for indicating whether the target data is repeatedly played after the playback ends; or
a sixth property, used for indicating a playback period of the target data.

3. The method according to claim 2, wherein the first property is a start time, and is configured to indicate a time when the rendering engine starts rendering media information associated with the target node or the target object.

4. The method according to claim 2, wherein the second property is auto play, and is configured to indicate whether to play a media signal immediately when the media signal is ready.

5. The method according to claim 1, wherein the target node or the target object comprises at least one of the following:
a haptic source node or a haptic source object;
a trigger node or a trigger object;
a behavior node or a behavior object; or
a haptic action node or a haptic action object.

6. The method according to claim 5, wherein when the target node or the target object is a haptic source node or a haptic source object, the rendering engine obtains and renders haptic data based on a property corresponding to the haptic source node or the haptic source object.

7. The method according to claim 5, wherein the haptic source node or the haptic source object is a haptic source node or a haptic source object that generates a haptic signal.

8. The method according to claim 1, wherein the target property is in a default state, and the obtaining, by the rendering engine, target data based on a target property associated with the target node or the target object comprises:
obtaining, by the rendering engine, the target data at any time.

9. The method according to claim 5, wherein the monitoring, by a rendering engine, a target node or a target object comprises:
monitoring, by the rendering engine, the haptic action node or the haptic action object when the trigger node or the trigger object is set to a default state.

10. The method according to claim 1, wherein the target property further comprises a seventh property, and the seventh property is used for indicating a trigger type of the target data.

11. A communication device, comprising a processor and a memory, wherein the memory stores a program or instructions executable in the processor, wherein the program or the instructions, when executed by the processor, cause the communication device to perform:
monitoring, by a rendering engine, a target node or a target object; and
obtaining, by the rendering engine, target data based on a target property associated with the target node or the target object,
wherein the target property comprises a time property.

12. The communication device according to claim 11, wherein the time property comprises at least one of the following:
a first property, used for indicating a time when the rendering engine starts rendering the target data;
a second property, used for indicating whether to play immediately when the target data is ready;
a third property, used for indicating a time when playback of the target data starts;
a fourth property, used for indicating a time when the playback of the target data ends;
a fifth property, used for indicating whether the target data is repeatedly played after the playback ends; or
a sixth property, used for indicating a playback period of the target data.

13. The communication device according to claim 12, wherein the first property is a start time, and is configured to indicate a time when the rendering engine starts rendering media information associated with the target node or the target object.

14. The communication device according to claim 12, wherein the second property is auto play, and is configured to indicate whether to play a media signal immediately when the media signal is ready.

15. The communication device according to claim 11, wherein the target node or the target object comprises at least one of the following:
a haptic source node or a haptic source object;
a trigger node or a trigger object;
a behavior node or a behavior object; or
a haptic action node or a haptic action object.

16. The communication device according to claim 15, wherein when the target node or the target object is a haptic source node or a haptic source object, the rendering engine obtains and renders haptic data based on a property corresponding to the haptic source node or the haptic source object.

17. The communication device according to claim 15, wherein the haptic source node or the haptic source object is a haptic source node or a haptic source object that generates a haptic signal.

18. The communication device according to claim 11, wherein the target property is in a default state, wherein when obtaining target data based on a target property associated with the target node or the target object, the program or the instructions, when executed by the processor, cause the communication device to perform:
obtaining, by the rendering engine, the target data at any time.

19. The communication device according to claim 15, wherein when monitoring a target node or a target object, the program or the instructions, when executed by the processor, cause the communication device to perform:
monitoring, by the rendering engine, the haptic action node or the haptic action object when the trigger node or the trigger object is set to a default state.

20. A non-transitory readable storage medium, wherein the non-transitory readable storage medium stores a program or instructions, wherein the program or the instructions, when executed by a processor of a communication device, cause the communication device to perform:
monitoring, by a rendering engine, a target node or a target object; and
obtaining, by the rendering engine, target data based on a target property associated with the target node or the target object,
wherein the target property comprises a time property.
